(19) United States
(12) Patent Application Publication
(10) Pub. No.: US 2015/0172641 A1
(43) Pub. Date: Jun. 18, 2015

(54) IMAGE PROCESSING DEVICE, STEREOSCOPIC IMAGE DISPLAY DEVICE, AND IMAGE PROCESSING METHOD

(71) Applicant: KABUSHIKI KAISHA TOSHIBA, Tokyo (JP)

(72) Inventors: Norihiro NAKAMURA, Kawasaki (JP); Yasunori TAGUCHI, Kawasaki (JP)

(73) Assignee: KABUSHIKI KAISHA TOSHIBA

(21) Appl. No.: 14/569,882

(22) Filed: Dec. 15, 2014

(30) Foreign Application Priority Data
Dec. 16, 2013 (JP) 2013-259297

(51) Int. Cl. H04N 13/04; H04N 13/00

(52) U.S. Cl. CPC H04N 13/0409; H04N 13/0497; H04N 13/0022

(57) ABSTRACT

According to an embodiment, an image processing device includes an obtainer to obtain parallax images; first and second calculators; and first and second generators. The first calculator calculates, for each light ray defined according to combinations of pixels included in each display element, first map-information associated with a luminance value of the parallax image corresponding to the light ray. The first generator generates, for each parallax image, feature data in which a first value corresponding to a feature value of the parallax image is a pixel value. Based on feature data corresponding to each parallax image, the second calculator calculates, for each light ray, second map-information associated with the first value of the feature data corresponding to the light ray. Based on the first and second map-information, the second generator decides on luminance values of pixels included in each display element, to generate an image displayed on each display element.

### CROSS-REFERENCE TO RELATED APPLICATIONS

This application is based upon and claims the benefit of priority from Japanese Patent Application No. 2013-259297, filed on Dec. 16, 2013; the entire contents of which are incorporated herein by reference.

### FIELD

Embodiments described herein relate generally to an image processing device, a stereoscopic image display device, and an image processing method.

### BACKGROUND

In recent years, in the field of medical diagnostic imaging devices such as X-ray computer tomography (CT) scanners, magnetic resonance imaging (MRI) scanners, or ultrasound diagnostic devices; devices capable of generating three-dimensional medical images (volume data) have been put to practical use. Moreover, a technology for rendering of the volume data from arbitrary viewpoints has also been put into practice. In recent years, a technology is being examined in which the volume data can be rendered from a plurality of viewpoints and displayed in a stereoscopic manner in a stereoscopic image display device.

In a stereoscopic image display device, a viewer is able to view stereoscopic images with the unaided eye without having to use special glasses. As such a stereoscopic image display device, a commonly-used method includes displaying a plurality of images having different viewpoints (in the following explanation, each such image is called a parallax image), and controlling the light rays from the parallax images using an optical aperture (such as a parallax barrier or a lenticular lens). The displayed images are rearranged in such a way that, when viewed through the optical aperture, the intended images are seen in the intended directions. The light rays that are controlled using the optical aperture and using the rearrangement of the images in concert with the optical aperture are guided to both eyes of the viewer. At that time, if the viewer is present at an appropriate viewing position, he or she becomes able to recognize a stereoscopic image. The range within which the viewer is able to view stereoscopic images is called a visible area.

In the method mentioned above, it becomes necessary to have a display panel (a display element) that is capable of displaying the stereoscopic images at the resolution obtained by summing the resolutions of all parallax images. Hence, if the number of parallax images is increased, then there occurs a decline in the resolution by an amount equal to the resolution permitted per parallax image, and the image quality deteriorates. On the other hand, if the number of parallax images is reduced, then the visible area becomes narrower. As a method of mitigating the tradeoff relationship between the 3D image quality and the visible area, a method has been proposed in which a plurality of display panels is laminated and stereoscopic viewing is made possible by displaying an images which is optimized in such a way that the combination of luminance values of the pixels in each display panel express a parallax image. In this method, each pixel is reused in expressing a plurality of parallax images. Hence, as compared to the conventional unaided-eye 3D display method, it is more likely to be able to display high-resolution stereoscopic images.

In the method in which a plurality of display panels is laminated for the purpose of displaying a stereoscopic image; greater the set visible area, more is the increase in the required number of parallax images and higher is the likelihood that each pixel is reused. Thus, in this method, as a result of reusing each pixel for expressing a plurality of parallax images, it becomes possible to express parallax images that are greater in number than the expression ability of the display panels. However, if the possibility of reuse becomes excessive, then there exists no solution that can satisfy all criteria. Hence, there occurs a marked decline in the image quality and the stereoscopic effect.

In U.S. Patent Application Publication No. 2012-0140131 A1 and Tensor Displays: Compressive Light Field Synthesis using Multilayer Displays with Directional Backlighting, in order to reduce the possibility of reuse, the portion within the visible area that does not affect the vision (i.e., the combination of pixels corresponding to the light rays not passing through the visible area) is either not taken into account during the optimization or is combined with the optical aperture so that the increase in the required number of parallaxes is held down. Regardless of that, if the image quality and the number of parallaxes are to be guaranteed in a suitable manner for practical use, then the number of laminations needs to increase. However, an increase in the number of laminations leads to an increase in the cost and a decline in the display luminance. Hence, there is a demand to reduce the number of laminations as much as possible.

### BRIEF DESCRIPTION OF THE DRAWINGS

FIG. 1 is a diagram illustrating an exemplary configuration of an image display system according to an embodiment;

FIG. 2 is a diagram for explaining an example of volume data according to the embodiment;

FIG. 3 is a diagram illustrating an exemplary configuration of a stereoscopic image display device according to the embodiment;

FIGS. 4A and 4B are diagrams for explaining first map-information according to the embodiment;

FIG. 5 is a diagram for explaining second map-information according to the embodiment;

FIGS. 6A and 6B are diagrams for explaining third map-information according to the embodiment; and

FIG. 7 is a flowchart for explaining an example of the operations performed in the stereoscopic image display device according to the embodiment.

### DETAILED DESCRIPTION

According to an embodiment, an image processing device includes an obtainer, a first calculator, a first generator, a second calculator, and a second generator. The obtainer obtains a plurality of parallax images. The first calculator calculates, for each of a plurality of light rays defined according to combinations of pixels included in each of a plurality of display elements that are disposed in a stack, first map-information that is associated with a luminance value of the parallax image corresponding to the light ray. The first generator generates, for each of the plurality of parallax images, feature data in which a first value corresponding to a feature value of the parallax image is treated as a pixel value. Based on the plurality of pieces of feature data respectively corresponding to the plurality of parallax images, the second calculator calculates, for each of the light rays, second map-information that is associated with the first value of the feature data corresponding to the light ray. Based on the first map-information and the second map-information, the second generator decides on luminance values of the pixels included in each of the plurality of display elements, to thereby generate an image to be displayed on each of the plurality of display elements.

An exemplary embodiment of an image processing device, a stereoscopic image display device, and an image processing method is described below in detail with reference to the accompanying drawings.

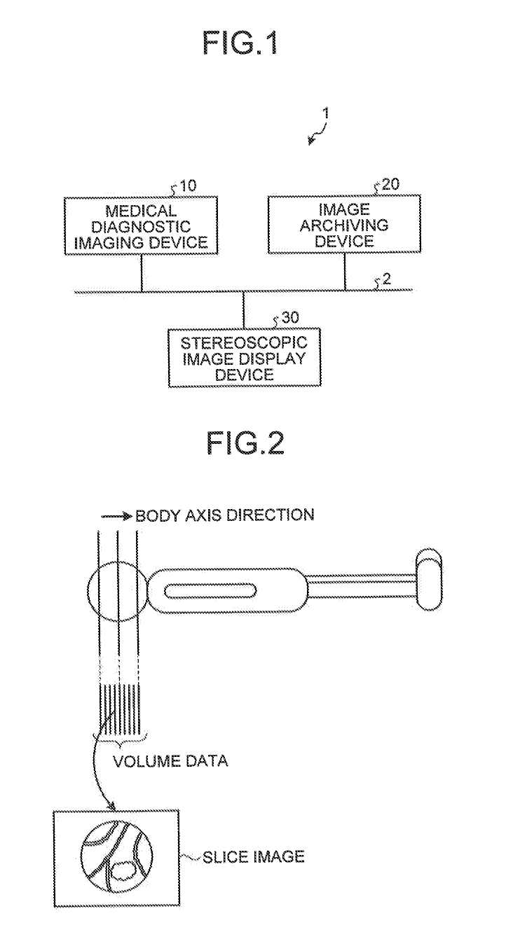

FIG. 1 is a block diagram illustrating an exemplary configuration of an image display system 1 according to the embodiment. As illustrated in FIG. 1, the image display system 1 includes a medical diagnostic imaging device 10, an image archiving device 20, and a stereoscopic image display device 30. Each device illustrated in FIG. 1 is communicable to each other directly or indirectly via a communication network 2. Thus, each device is capable of sending medical images to and receiving medical images from the other devices. The communication network 2 can be of any arbitrary type. For example, the devices may be mutually communicable via a local area network (LAN) installed in a hospital. Alternatively, for example, the devices may be mutually communicable via a network (cloud) such as the Internet.

In the image display system 1, stereoscopic images are generated from volume data of three-dimensional medical images, which is generated by the medical diagnostic imaging device 10. Then, the stereoscopic image display device 30 displays the stereoscopic images with the aim of providing stereoscopically viewable medical images to doctors or laboratory personnel working in the hospital. Herein, a stereoscopic image is an image that includes a plurality of parallax images having mutually different parallaxes. The parallax means the difference in vision when viewed from a different direction. Meanwhile, herein, an image can either be a still image or be a moving image. The explanation of each device is given below in order.

The medical diagnostic imaging device 10 is capable of generating volume data of three-dimensional medical images. As the medical diagnostic imaging device 10; it is possible to use, for example, an X-ray diagnostic apparatus, an X-ray computer tomography (CT) scanner, a magnetic resonance imaging (MRI) scanner, an ultrasound diagnostic device, a single photon emission computer tomography (SPECT) device, a positron emission computer tomography (PET) device, a SPECT-CT device configured by integrating a SPECT device and an X-ray CT device, a PET-CT device configured by integrating a PET device and an X-ray CT device, or a group of these devices.

The medical diagnostic imaging device 10 captures images of a subject being tested, and generates volume data. For example, the medical diagnostic imaging device 10 captures images of a subject being tested; collects data such as projection data or MR signals; reconfigures a plurality of (for example, 300 to 500) slice images (cross-sectional images) along the body axis direction of the subject; and generates volume data. Thus, as illustrated in FIG. 2, a plurality of slice images, which is taken along the body axis direction of the subject, represents the volume data. In the example illustrated in FIG. 2, the volume data of the brain of the subject is generated. Meanwhile, the projection data or the MR signals of the subject, which is captured by the medical diagnostic imaging device 10, can itself be considered as the volume data. Moreover, the volume data generated by the medical diagnostic imaging device 10 contains images of internal organs such as bones, blood vessels, nerves, tumors, and the like that are observed at the medical front. Furthermore, the volume data may contain data in which the equivalent faces of the volume data are expressed using a set of geometric elements such as polygons or curved surfaces.

The image archiving device 20 is a database for archiving medical images. More particularly, the image archiving device 20 is used to store and archive the volume data sent by the medical diagnostic imaging device 10.

The stereoscopic image display device 30 displays stereoscopic images of the volume data that is generated by the medical diagnostic imaging device 10. According to the embodiment, in the stereoscopic image display device 30, a plurality of (at least two) display elements, each of which has a plurality of pixels arranged therein, is laminated; and a stereoscopic image is displayed by displaying a two-dimensional image on each display element.

Meanwhile, although the following explanation is given for an example in which the stereoscopic image display device 30 displays stereoscopic images of the volume data generated by the medical diagnostic imaging device 10; that is not the only possible case. Moreover, the source three-dimensional data of the stereoscopic images displayed by the stereoscopic image display device 30 can be of an arbitrary type. The three-dimensional data is the data that enables expression of the shape of a three-dimensional object, and may contain a spatial partitioning model or a boundary representation model of the volume data. The spatial partitioning model indicates a model in which, for example, the space is partitioned in a reticular pattern, and a three-dimensional object is expressed using the partitioned grids. The boundary representation model indicates a model in which, for example, a three-dimensional object is expressed by representing the boundary of the area covered by the three-dimensional object in the space.

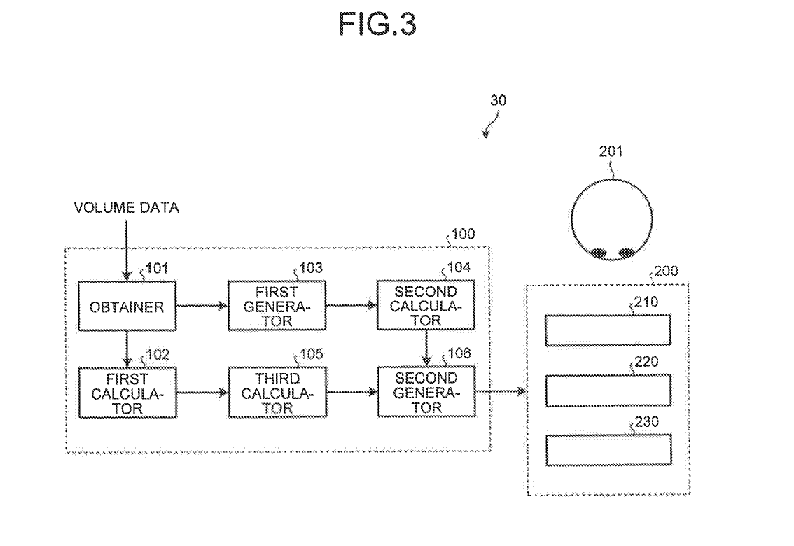

FIG. 3 is a block diagram illustrating an exemplary configuration of the stereoscopic image display device 30. As illustrated in FIG. 3, the stereoscopic image display device 30 includes an image processor 100 and a display 200. The display 200 includes a plurality of display elements laminated (stacked) together, and displays a stereoscopic image by displaying, on each display element, a two-dimensional image generated by the image processor 100. The following explanation is given for an example in which the display 200 includes two display elements (210 and 220) disposed in a stack. Moreover, the following explanation is given for an example in which each of the two display elements (210 and 220) included in the display 200 is configured with a liquid crystal display (a liquid crystal panel) that includes two transparent substrates facing each other and a liquid crystal layer sandwiched between the two transparent substrates. Moreover, the structure of the liquid crystal display can be of the active matrix type or the passive matrix type.

As illustrated in FIG. 3, the display 200 includes a first display element 210, a second display element 220, and a light source 230. In the example illustrated in FIG. 3, the first display element 210, the second display element 220, and the light source 230 are disposed in that order from the side nearer to a viewer 201. Moreover, in this example, the first display element 210 as well as the second display element 220 is configured with a transmissive liquid crystal display. As the light source 230, it is possible to make use of a cold-cathode tube, a hot-cathode fluorescent light, an electroluminescence panel, a light-emitting diode, or an electric light bulb. Meanwhile, for example, the liquid crystal displays used herein can also be configured as reflective liquid crystal displays. In that case, as the light source 230, it is possible to use a reflecting layer that reflects the outside light such as the natural sunlight or the indoor electric light. Alternatively, for example, the liquid crystal displays can be configured as semi-transmissive liquid crystal displays having a combination of the transmissive type and the reflective type.

The image processor 100 performs control of displaying a stereoscopic image by displaying a two-dimensional image on each display element (210 and 220). In the embodiment, the image processor 100 optimizes the luminance values of the pixels of each display element (210 and 220) so as to ensure that the portion having a greater feature value in the target stereoscopic image for display is displayed at a high image quality. Given below is the explanation of specific details of the image processor 100. In this specification, the “feature value” serves as an indicator that has a greater value when the likelihood of affecting the image quality is higher.

As illustrated in FIG. 3, the image processor 100 includes an obtainer 101, a first calculator 102, a first generator 103, a second calculator 104, a third calculator 105, and a second generator 106.

The obtainer 101 obtains a plurality of parallax images. In the embodiment, the obtainer 101 accesses the image archiving device 20 and obtains the volume data generated by the medical diagnostic imaging device 10. Meanwhile, instead of using the image archiving device 20, it is also possible to install a memory inside the medical diagnostic imaging device 10 for storing the generated volume data. In that case, the obtainer 101 accesses the medical diagnostic imaging device 10 and obtains the volume data.

Moreover, at each of a plurality of viewpoint positions (positions at which virtual cameras are disposed), the obtainer 101 performs rendering of the obtained data and generates a plurality of parallax images. During rendering of the volume data, it is possible to use various known volume rendering techniques such as the ray casting method. Herein, although the explanation is given for an example in which the obtainer 101 has the function of performing rendering of the volume data at a plurality of viewpoint positions and generating a plurality of parallax images, that is not the only possible case. Alternatively, for example, the configuration may be such that the obtainer 101 does not have the volume rendering function. In such a configuration, the obtainer 101 can obtain, from an external device, a plurality of parallax images that represents the result of rendering of the volume data, which is generated by the medical diagnostic imaging device 10, at a plurality of viewpoint positions. In essence, as long as the obtainer 101 has the function of obtaining a plurality of parallax images, it serves the purpose.

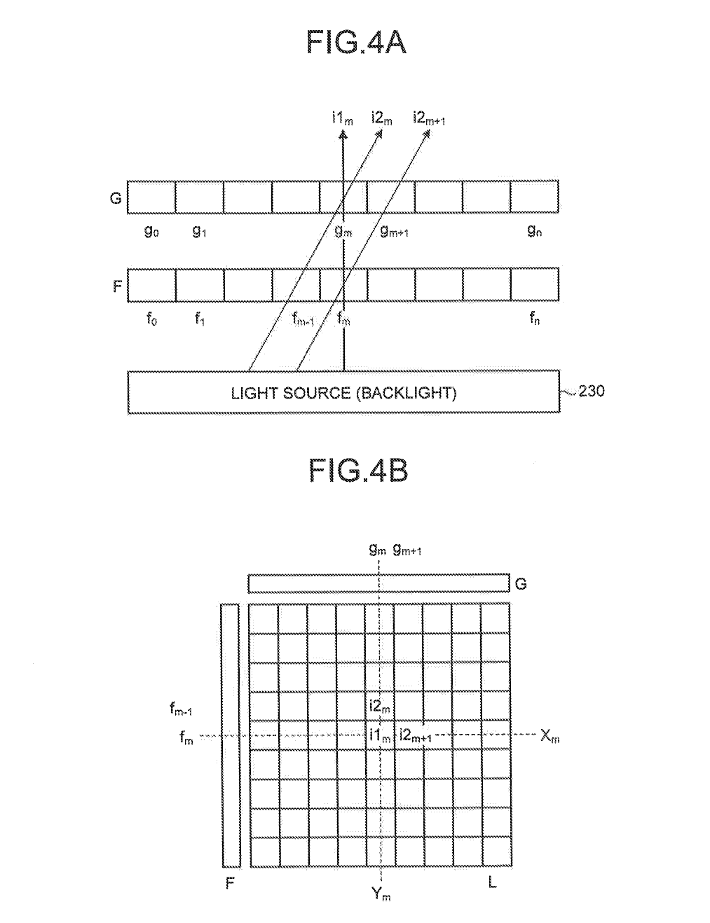

The first calculator 102 calculates, for each of plurality of light rays defined according to a combination of pixels included in each of a plurality of display elements (210 and 220) disposed in a stack, first map-information L associated with the luminance value of the parallax image corresponding to that light ray. Herein, the first map-information L is assumed to be identical to the information defined as 4D Light Fields in U.S. Patent Application Publication No. 2012-0140131 A1. With reference to FIGS. 4A and 4B, it is assumed that the pixel structure of the first display element 210 and the pixel structure of the second display element 220 are one-dimensionally expanded for convenience. For example, with reference to the row direction of a pixel structure in which the pixels are arranged in a matrix-like manner, it can be considered that rearrangement is done by linking the end of a row to the beginning of the next row.

In the following explanation, the set of pixels arranged in the first display element 210 is sometimes written as “G” and the set of pixels arranged in the second display element 220 is sometimes written as “F”. In the example illustrated in FIGS. 4A and 4B, the number of pixels included in the first display element 210 is assumed to be equal to n+1, and each of a plurality of pixels included in the first display element 210 is written as gₓ (x=0 to n). Moreover, the number of pixels included in the second display element 220 is assumed to be equal to n+1, and each of a plurality of pixels included in the second display element 220 is written as fₓ (x=0 to n).

Consider a case in which a single pixel is selected from the first display element 210 as well as from the second display element 220. In that case, it is possible to define a vector that joins the representative points of those two pixels (for example, the centers of the pixels). In the following example, that vector is sometimes referred to as a “model light ray vector”, and the light ray expressed by the model light ray vector is sometimes referred to as a “model light ray”. In this example, the model light ray can be thought to be corresponding to a “light ray” mentioned in claims. The model light ray vector represents the direction of the light ray, from among the light rays emitted from the light source 230, which passes through the two selected points. If the luminance value of that particular light ray coincides with the luminance value of the parallax image corresponding to the direction of that light ray, then it means that the parallax image corresponding to each viewpoint is viewable at that viewpoint. As a result, the viewer becomes able to view the stereoscopic image. When the relationship between the model light ray and the parallax image is expressed in the form of a tensor (a multidimensional array), it is the first map-information L.

Given below is the explanation of a specific method of creating the first map-information L. Firstly, as the first step, the first calculator 102 selects a single pixel from the first display element 210 as well as from the second display element 220.

As the second step, the first calculator 102 determines the luminance value (the true luminance value) of the parallax image corresponding to the model light ray vector (the model light ray) that is defined according to the combination of the two pixels selected at the first step. Herein, based on the angles determined by the panel (the display 200) and the cameras, a single viewpoint corresponding to the model light vector is selected, and the parallax image corresponding to the selected viewpoint is identified. More particularly, for each of a plurality of preinstalled cameras, the vector starting from the camera to the center of the panel (in the following explanation, sometimes referred to as a “camera vector”) is defined. Then, of a plurality of camera vectors respectively corresponding to a plurality of cameras, the first calculator 102 selects the camera vector having the closest orientation to the model light ray vector, and identifies the parallax image corresponding to the viewpoint position of the selected camera vector (i.e., corresponding to the position of the concerned camera) to be the parallax image corresponding to the model light ray vector.

In the example illustrated in FIG. 4A, the parallax image corresponding to a viewpoint i1 is identified as the parallax image corresponding to the model light ray vector that is defined according to the combination of the m-th pixel gₘ selected from the first display element 210 and the m-th pixel fₘ selected from the second display element 220. Moreover, the parallax image corresponding to a viewpoint i2 is identified as the parallax image corresponding to the model light ray vector that is defined according to the combination of the m-th pixel gₘ selected from the first display element 210 and the (m−1)-th pixel fₘ₋₁ selected from the second display element 220. Furthermore, the parallax image corresponding to a viewpoint i2 is identified as the parallax image corresponding to the model light ray vector that is defined according to the combination of the (m+1)-th pixel gₘ₊₁ selected from the first display element 210 and the m-th pixel fₘ selected from the second display element 220.

Then, the first calculator 102 determines a spatial position within the parallax image corresponding to the model light ray vector, and determines the luminance value at that position to be the true luminance value. For example, with reference to either one of the first display element 210 and the second display element 220, the position in the parallax image that corresponds to the position of the selected pixel in the reference display element can be determined to be the position within the parallax image corresponding to the model light ray vector. However, that is not the only possible case. Alternatively, for example, with reference to the planar surface passing through the central positions of the first display element 210 and the second display element 220, the position at which the model light ray vector intersects with the reference planar surface is calculated, and the position in the parallax image that corresponds to the position of intersection can be determined to be the position within the parallax image corresponding to the model light ray vector.

In the example illustrated in FIG. 4A, it is assumed that a luminance value i1ₘ is determined to be the luminance value (the true luminance value) at the position within the parallax image corresponding to the model light ray vector that is defined according to the combination of the m-th pixel gₘ selected from the first display element 210 and the m-th pixel fₘ selected from the second display element 220 (i.e., at the position within the parallax image corresponding to the viewpoint i1). Moreover, it is assumed that a luminance value i2ₘ is determined to be the luminance value (the true luminance value) at the position within the parallax image corresponding to the model light ray vector that is defined according to the combination of the m-th pixel gₘ selected from the first display element 210 and the (m−1)-th pixel fₘ₋₁ selected from the second display element 220 (i.e., at the position within the parallax image corresponding to the viewpoint i2). Furthermore, it is assumed that a luminance value i2ₘ₊₁ is determined to be the luminance value (the true luminance value) at the position within the parallax image corresponding to the model light ray vector that is defined according to the combination of the (m+1)-th pixel gₘ₊₁ selected from the first display element 210 and the m-th pixel fₘ selected from the second display element 220 (i.e., at the position within the parallax image corresponding to the viewpoint i2).

As the third step, the column that corresponds to the pixel selected from the second display element 220 at the first step is selected. In the example illustrated in FIG. 48, the first display element 210 having the one-dimensionally expanded pixel structure is treated as rows, and the second display element 220 having the one-dimensionally expanded pixel structure is treated as columns. Hence, for example, of the set F of pixels of the second display element 220 that are arranged in the column direction, when the m-th pixel fₘ is selected at the first step, then a row Xₘ is selected that intersects with the column direction at the position of the m-th pixel fₘ.

As the fourth step, the column that corresponds to the pixel selected from the first display element 210 at the first step is selected. As described above, in the example illustrated in FIG. 4B, the first display element 210 having the one-dimensionally expanded pixel structure is treated as rows, and the second display element 220 having the one-dimensionally expanded pixel structure is treated as columns. Hence, for example, of the set G of pixels of the first display element 210 that are arranged in the row direction, when the m-th pixel gₘ is selected at the first step, then a column Yₘ is selected that intersects with the row direction at the position of the m-th pixel gₘ.

As the fifth step, in the element corresponding to the intersection between the row selected at the third step and the column selected at the first step, the luminance value determined at the second step is substituted. For example, at the third step, when the row Xₘ is selected that intersects with the m-th pixel fₘ of the set F of pixels of the second display element 220 which are arranged in the column direction, and, at the fourth step, when the column Yₘ is selected that intersects with the m-th pixel gₘ of the set G of pixels of the first display element 210 which are arranged in the row direction; the luminance value i1ₘ that is determined at the second step (i.e., the luminance value i1ₘ that is determined as the luminance value at the position within the parallax image corresponding to the model light ray vector which is defined according to the combination of the m-th pixel gₘ selected from the first display element 210 and the m-th pixel fₘ selected from the second display element 220) is substituted as the element corresponding to the intersection between the row Xₘ and the column Yₘ. As a result, it is possible to think that the luminance value i1ₘ of the parallax image corresponding to the model light ray gets associated with the model light ray vector which is defined according to the combination of the m-th pixel gₘ selected from the first display element 210 and the m-th pixel fₘ selected from the second display element 220.

Until all combinations of the pixels included in the first display element 210 and the pixels included in the second display element 220 are processed, the first calculator 102 can repeat the first step to the fifth step and calculate the first map-information L.

In the embodiment, the explanation is given for an example in which two display elements are disposed in a stack. However, that is not the only possible case. Alternatively, it is obviously possible to dispose three or more display elements in a laminated manner. For example, in the case of laminating three display elements; in addition to the set G of pixels arranged in the first display element 210 and the set F of pixels arranged in the second display element 220, a set H of pixels arranged in a third display element is also taken into account. Consequently, the tensor also becomes a three-way tensor. Then, the operations performed on the sets F and G are performed also on the set H so that the position of the element corresponding to the model light ray and the true luminance value can be determined. In essence, it is sufficient that, for each of a plurality of light rays defined according to the combinations of pixels included in a plurality of display elements laminated with each other, the first calculator 102 can calculate the first map-information that is associated with the luminance value of the parallax image corresponding to that light ray.

Given below is the explanation of the first generator 103 illustrated in FIG. 3. For each of a plurality of parallax images obtained by the obtainer 101, the first generator 103 generates feature data in which a first value corresponding to the feature value of the parallax image is treated as the pixel value. In the embodiment, as the feature value, the following four types of information are used: the luminance gradient of the parallax image; the gradient of depth information; the depth position obtained by converting the depth information in such a way that the depth position represents a greater value closer to the pop-out side; and an object recognition result defined in such a way that the pixels corresponding to a recognized object represent greater values as compared to the pixels not corresponding to the object.

In this example, each of a plurality of pieces of feature data respectively corresponding to a plurality of parallax images represents image information having an identical resolution to the corresponding parallax image. Moreover, each pixel value (the first value) of the feature data is defined as the linear sum of the four types of the feature value (the luminance gradient of the parallax image, the gradient of the depth information, the depth position, and the object recognition result) extracted from the corresponding parallax image. These types of the feature value are defined as two-dimensional arrays (matrices) in an identical manner to images. With respect to each of a plurality of parallax images, the first generator 103 generates, based on the corresponding parallax image, image information I_{g} in which the luminance gradient is treated as the pixel value; image information I_{de} in which the luminance gradient of the depth information is treated as the pixel value; image information I_{d} in which the depth position is treated as the pixel value; and image information I_{obj} in which the object recognition result is treated as the pixel value. Then, the first generator 103 obtains the weighted linear sum of all pieces of image information, and generates feature data Iₐₗₗ corresponding to the corresponding parallax image. The specific details are explained below.

Firstly, given below is the explanation of the method of generating the image information I_{g}. Herein, the image information I_{g} represents image information having an identical resolution to the corresponding parallax image, and a value according to the maximum value of the luminance gradient of that parallax image is defined as each pixel value. In the case of generating the image information I_{g} corresponding to a single parallax image, the first generator 103 refers to the luminance value of each pixel of the single parallax image; calculates the absolute value of luminance difference between the target pixel for processing and each of the eight neighbor pixels of the target pixel for processing and obtains the maximum value; and sets the maximum value as the pixel value of the target pixel for processing. In this case, the pixel value tends to be greater in the neighborhood of the edge boundary. Meanwhile, in this example, each pixel value of the image information I_{g} is normalized in the range of 0 to 1, and is set to a value within the range of 0 to 1 according to the maximum value of the luminance gradient. In this way, the first generator 103 generates the image information I_{g} having an identical resolution to the corresponding parallax image.

Given below is the explanation of the method of generating the image information I_{de}. Herein, the image information I_{de} represents image information having an identical resolution to the corresponding parallax image, and a value according to the maximum value of the gradient of the depth information of that parallax image is defined as each pixel value. In the embodiment, based on a plurality of parallax images obtained by the obtainer 101 (based on the amount of shift between parallax images), the first generator 103 generates, for each parallax image, a depth map that indicates the depth information of each of a plurality of pixels included in the corresponding parallax image. However, that is not the only possible case. Alternatively, for example, the obtainer 101 may generate a depth map of each parallax image and send it to the first generator 103. Still alternatively, the depth map of each parallax image may be obtained from an external device. Meanwhile, for example, in the obtainer 101, if ray tracing or ray casting is used at the time of generating parallax images; then it is possible to think of a method in which a depth map is generated based on the distance to the point at which a ray (a light ray) and an object are determined to have intersected for the first time.

In the case of generating the image information I_{de} corresponding to a single parallax image, the first generator 103 refers to the depth map of that parallax image; calculates the absolute value of depth information difference between the target pixel for processing and each of the eight neighbor pixels of the target pixel for processing and obtains the maximum value; and sets the maximum value as the pixel value of the target pixel for processing. In this case, the pixel value tends to be greater at the object boundary. Meanwhile, in this example, each pixel value of the image information I_{de} is normalized in the range of 0 to 1, and is set to a value within the range of 0 to 1 according to the maximum value of the gradient of the depth information. In this way, the first generator 103 generates the image information I_{de} having an identical resolution to the corresponding parallax image.

Given below is the explanation of the method of generating the image information I_{d}. Herein, the image information I_{d} represents image information having an identical resolution to the corresponding parallax image; and a value according to the depth position, which is obtained by converting the depth information in such a way that the depth position represents a greater value closer to the pop-out side, is defined as each pixel value. Then, the obtained depth value is set as the pixel value of the target pixel for processing. Meanwhile, in this example, each pixel value of the image information I_{d} is normalized in the range of 0 to 1, and is set to a value within the range of 0 to 1 according to the depth position. In this way, the first generator 103 generates the image information I_{d} having an identical resolution to the corresponding parallax image.

Given below is the explanation of the method of generating the image information I_{obj}. Herein, the image information I_{obj} represents image information having an identical resolution to the corresponding parallax image; and a value according to the object recognition result is defined as each pixel value. Examples of an object include a face or a character; and the object recognition result represents the feature value defined in such a way that the pixels recognized as a face or a character as a result of face recognition or character recognition have a greater value than the pixels not recognized as a face or a character. Herein, face recognition or character recognition can be implemented with various known technologies used in common image processing. In the case of generating the image information I_{obj} corresponding to a single parallax image, the first generator 103 performs an object recognition operation with respect to that parallax image, and sets each pixel value based on the object recognition result. Meanwhile, in this example, each pixel value of the image information I_{obj} is normalized in the range of 0 to 1, and is set to a value within the range of 0 to 1 according to the object recognition result. In this way, the first generator 103 generates the image information I_{obj} having an identical resolution to the corresponding parallax image.

Then, using weights having the total equal to 1.0, the first generator 103 obtains the weighted linear sum of the image information I_{g}, the image information I_{de}, the image information I_{d}, and the image information I_{obj}; and calculates the final feature data Iₐₗₗ. For example, the feature data Iₐₗₗ can be expressed using Equation 1 given below. In Equation 1, “a”, “b”, “c”, and “d” represent weights. Thus, if the weights “a” to “d” are adjusted, it becomes possible to variably set the type of feature value to be mainly taken into account from among the abovementioned types of feature value. In this example, each pixel value (the first value) of the feature data Iₐₗₗ is normalized to be equal to or greater than 0 but equal to or smaller than 1, and represents a value corresponding to the feature value.

Iₐₗₗ=aI_{g}+bI_{de}+cI_{d}+dI_{obj} (a+b+c+d=1.0) (1)

Meanwhile, in the embodiment, although the maximum value of the absolute values of the luminance gradient or the gradients of the depth information is extracted as the feature value, it is also possible to use the evaluation result obtained by evaluating the luminance gradient or the gradient of the depth information with some other method. For example, it is possible to think of a method of using the sum total of the absolute values of the differences with the eight neighbor pixels, or a method of performing evaluation over a wider range than the eight neighbor pixels. Aside from that, it is also possible to implement various commonly-used methods used in the field of image processing for evaluating the luminance gradient or the gradient of the depth information.

Moreover, in the embodiment, the luminance gradient of a parallax image, the gradient of the depth information, the depth position, and the object recognition result are all used as the feature value. However, it is not always necessary to use all of the information. Alternatively, for example, only either one of the luminance gradient of a parallax image, the gradient of the depth information, the depth position, and the object recognition result may be used as the feature value.

Still alternatively, for example, the combination of any two or any three of the luminance gradient of a parallax image, the gradient of the depth information, the depth position, and the object recognition result can be used as the feature value. That is, the feature value may be at least two of the luminance gradient of a parallax image, the gradient of the depth information, the depth position, and the object recognition result represent the feature value; and the pixel value (the first value) of the feature data corresponding to the parallax image may be obtained based on the weighted linear sum of at least two of the luminance gradient of a parallax image, the gradient of the depth information, the depth position, and the object recognition result.

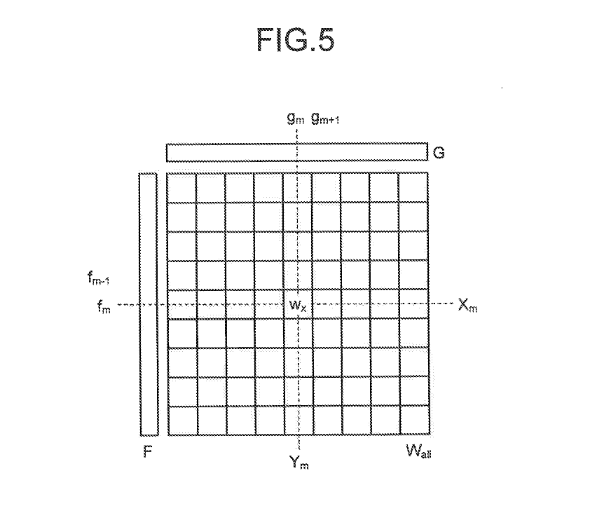

Given below is the explanation of the second calculator 104 illustrated in FIG. 3. Based on a plurality of pieces of feature data respectively corresponding to a plurality of parallax images obtained by the obtainer 101, the second calculator 104 calculates, for each model light ray, second map-information Wₐₗₗ that is associated with the pixel value (the first value) of the feature value corresponding to the model light ray. The second map-information Wₐₗₗ represents the relationship between the model light ray and the feature data in the form of a tensor (a multidimensional array). As the sequence of calculating the second map-information Wₐₗₗ; except for the fact that the feature data of a parallax image is used instead of using the parallax image itself, the calculation sequence is identical to the sequence of calculating the first map-information L. In the example illustrated in FIG. 5, as the pixel value (the first value) of the feature data corresponding to the model light ray vector (the model light ray) that is defined according to the combination of the m-th pixel gₘ selected from the first display element 210 and the m-th pixel fₘ selected from the second display element 220; of the feature data, a pixel value wx is decided that belongs to the position corresponding to such a position within the parallax image which corresponds to the model light ray vector (i.e., corresponding to the position indicating the luminance value i1ₘ). That is, the pixel value wx is substituted as an element corresponding to the intersection of the row Xₘ and the column Yₘ in the tensor.

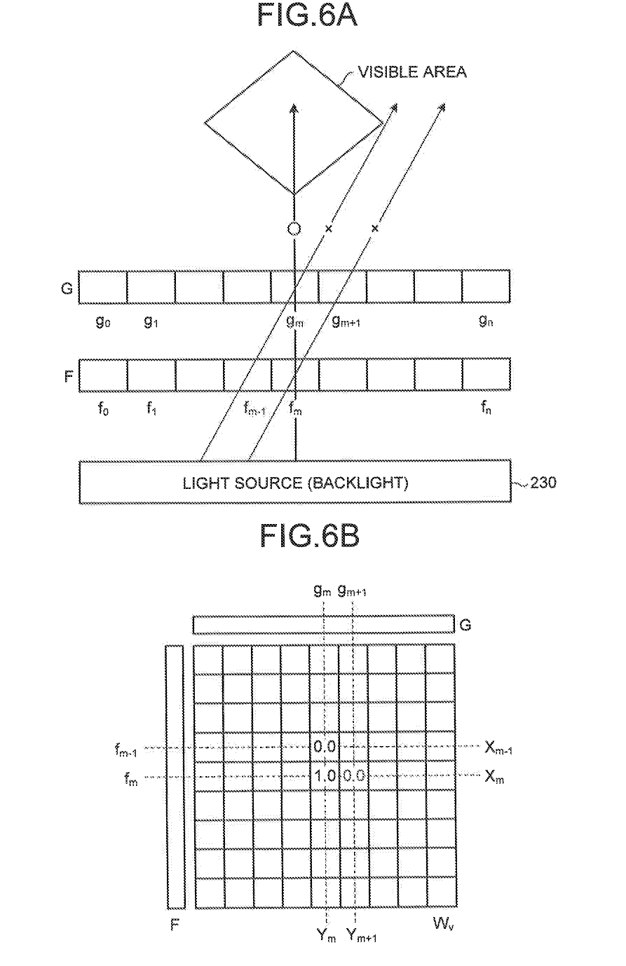

Given below is the explanation of the third calculator 105. For each model light ray, the third calculator 105 calculates third map-information Wᵥ that is associated with a second value that is based on whether or not the model light ray passes through a visible area specified in advance. The third map-information Wᵥ is identical to “W” mentioned in U.S. Patent Application Publication No. 2012-0140131 A1, and can be decided in an identical method to the method disclosed in U.S. Patent Application Publication No. 2012-0140131 A1. The third map-information Wᵥ represents the relationship between the model light ray and whether or not it passes through the visible area in the form of a tensor (a multidimensional array). For example, for each model light ray, the corresponding element on the tensor can be identified by following an identical sequence to the first map-information L. Then, as illustrated in FIG. 6B, with respect to the model light rays passing through the visible area specified in advance, “1.0” can be set as the second value. In contrast, with respect to the model light rays not passing through the visible area specified in advance, “0.0” can be set as the second value.

In the example illustrated in FIG. 6A, the model light ray vector (the model light ray) that is defined according to the combination of the m-th pixel gₘ selected from the first display element 210 and the m-th pixel fₘ selected from the second display element 220 passes through the visible area. Hence, as illustrated in FIG. 6B, as an element corresponding to the intersection between the row Xₘ, which bisects the m-th pixel fₘ of the set F of pixels of the second display element 220 that are arranged in the row direction, and the column Yₘ, which bisects the m-th pixel gₘ of the set G of pixels of the first display element 210 that are arranged in the column direction; the second value “1.0” is substituted.

However, in the example illustrated in FIG. 6A, the model light ray vector (the model light ray) that is defined according to the combination of the m-th pixel gₘ selected from the first display element 210 and the (m−1)-th pixel fₘ₋₁ selected from the second display element 220 does not pass through the visible area. Hence, as illustrated in FIG. 6B, as an element corresponding to the intersection between a row Xₘ₋₁, which bisects the (m−1)-th pixel fₘ₋₁ of the set F of pixels of the second display element 220 that are arranged in the row direction, and the column Yₘ, which bisects the m-th pixel gₘ of the set G of pixels of the first display element 210 that are arranged in the column direction; the second value “0.0” is substituted. In an identical manner, in the example illustrated in FIG. 6A, the model light ray vector (the model light ray) that is defined according to the combination of the (m+1)-th pixel gₘ₊₁ selected from the first display element 210 and the m-th pixel fₘ selected from the second display element 220 does not pass through the visible area. Hence, as illustrated in FIG. 6B, as an element corresponding to the intersection between the row Xₘ, which bisects the m-th pixel fₘ of the set F of pixels of the second display element 220 that are arranged in the row direction, and a column Yₘ₊₁, which bisects the (m+1)-th pixel gₘ₊₁ of the set G of pixels of the first display element 210 that are arranged in the column direction; the second value “0.0” is substituted.

Given below is the explanation of the second generator 106 illustrated in FIG. 3. In the embodiment, based on the first map-information L, the second map-information Wₐₗₗ, and the third map-information Wᵥ; the second generator 106 decides on the luminance values of the pixels included in the first display element 210 as well as the second display element 220. More particularly, the second generator 106 decides on the luminance values of the pixels included in the first display element 210 as well as the second display element 220 in such a way that, greater the result of multiplication of the pixel value (the first value) of the feature data corresponding to a model light ray and the second value (“1.0” or “0.0”) corresponding to that model light ray, higher is the priority with which the luminance value of the parallax image corresponding to the corresponding model light ray is obtained. More specifically, the second generator 106 optimizes Equation 2 given below, and decides on the luminance values of the pixels included in the first display element 210 as well as the second display element 220. In Equation 2 given below, F represents an I×1 vector, and I represents the number of pixels of F. Moreover, in Equation 2 given below, G represents a J×1 vector, and J represents the number of pixels of G.

$$arg min \frac{1}{2} {‖ L - FG ‖}_{{w}_{all} * {W}_{v}}^{2} L , F , G \geq 0 \\ \frac{1}{2} {‖ L - FG ‖}_{{w}_{all} * {W}_{v}}^{2} = {\sum }_{i , j}^{ } [ {W}_{all} * {W}_{v} * ( L - FG ) * ( L - FG ) ] \qquad ( 2 )$$

where, “*” represents Hadamard product.

As described earlier, F and G represent one-dimensional expansion of images. After the optimization of Equation 2, the rule thereof is used the other way round to make two-dimensional expansion so that an image that should be displayed in F and G can be obtained. Such a method of optimizing F and G under the restriction that F and G are unknown and that L, F, and G take only positive values is commonly known as NTF (in the case of a two-way tensor, NMF) and can be obtained through convergence calculation.

For example, it is assumed that, as illustrated in FIGS. 4A and 4B, the luminance value i1ₘ is determined to be the luminance value of the parallax image corresponding to the model light ray that is defined according to the combination of the m-th pixel gₘ selected from the first display element 210 and the m-th pixel fₘ selected from the second display element 220. Moreover, it is assumed that, with reference to FIG. 5, the pixel value wx of the feature data corresponding to that model light ray is equal to “1.0” which represents the upper limit value. Furthermore, it is assumed that, as illustrated in FIGS. 6A and 6B, the second value corresponding to that model light ray is equal to “1.0”. In this case, regarding the model light ray that is defined according to the combination of the m-th pixel gₘ selected from the first display element 210 and the m-th pixel fₘ selected from the second display element 220, the result of multiplication of the pixel value (the first value) and the second value of the corresponding feature data is equal to “1.0” which represents the upper limit value of priority, and the luminance value i1m of the parallax image corresponding to the model light ray happens to have the highest priority. Hence, the luminance value of the m-th pixel gₘ is selected from the first display element 210 and the luminance value of the m-th pixel fₘ is selected from the second display element 220 in such a way that the luminance value i1m is ensured.

Meanwhile, in Equation 2 given above, although F and G represent vectors, that is not the only possible case. Alternatively, for example, in an identical manner to U.S. Patent Application Publication No. 2012-0140131 A1, F and G can be optimized as matrices. That is, F can be solved as a matrix of I×T, and G can be solved as a matrix of T×J. In this case, if F is considered to be an image having a block of column vectors Ft, if G is considered to be an image having a block of row vectors Gt, and if F and G are displayed by temporally switching the display therebetween; then it becomes possible to obtain a display corresponding to FG given in Equation 2. In this case, attention is paid to the fact that the vectors having the same index corresponding to T are switched as a single set. For example, when T=2 is satisfied; F₁ and G₁ constitute a single set and F₂ and G₂ constitute a single set, and temporal switching is done in the units of these sets.

Meanwhile, the image processor 100 described above has a hardware configuration including a central processing unit (CPU), a read only memory (ROM), a random access memory (RAM), and a communication I/F device. The functions of each constituent element described above (i.e., each of the obtainer 101, the first calculator 102, the first generator 103, the second calculator 104, the third calculator 105, and the second generator 106) get implemented when the CPU reads computer programs stored in the ROM, loads them in the RAM, and executes them. However, that is not the only possible case. Alternatively, the functions of at least some of the constituent elements can be implemented using dedicated hardware circuitry (such as a semiconductor integrated circuit). The image processor 100 according to the embodiment corresponds to an “image processing device” mentioned in claims.

The computer programs executed in the image processor 100 can be saved as downloadable files on a computer connected to the Internet or can be made available for distribution through a network such as the Internet. Alternatively, the computer programs executed in the image processor 100 can be stored in advance in a nonvolatile memory medium such as a ROM.

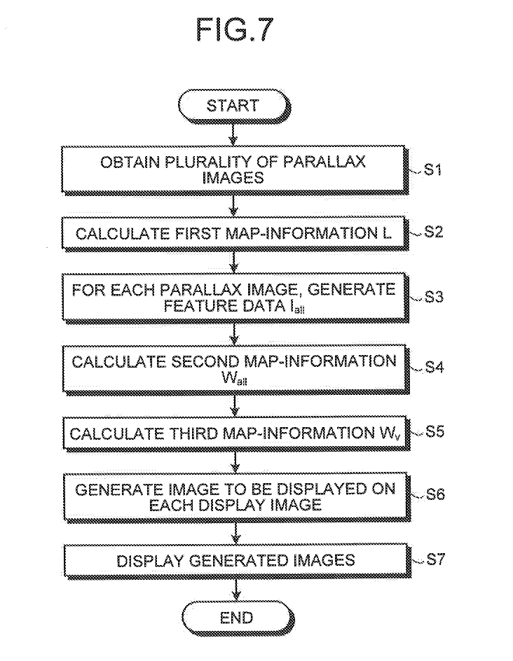

Explained below with reference to FIG. 7 is an example of the operations performed in the stereoscopic image display device 30 according to the embodiment. FIG. 7 is a flowchart for explaining an example of the operations performed in the stereoscopic image display device 30.

As illustrated in FIG. 7, firstly, the obtainer 101 obtains a plurality of parallax images (Step S1). Then, using the parallax images obtained at Step S1, the first calculator 102 calculates the first map-information L (Step S2). Subsequently, for each parallax image obtained at Step S1, the first generator 103 generates the four pieces of image information (I_{g}, I_{de}, I_{d}, and I_{obj}) based on the corresponding parallax image; and generates the feature data Iₐₗₗ in the form of the weighted linear sum of the four pieces of image information (Step S3). Then, based on a plurality of pieces of feature data Iₐₗₗ respectively corresponding to the parallax images obtained at Step S1, the second calculator 104 calculates, for each model light ray, the second map-information Wₐₗₗ that is associated with the pixel value (the first value) of the feature data corresponding to the corresponding model light ray (Step S4). Subsequently, using visible area information indicating a visible area specified in advance, the third calculator 105 calculates, for each model light ray, the third map-information Wᵥ that is associated with the second value which is based on whether or not the model light ray passes through the visible area specified in advance (Step S5). Then, based on the first map-information L calculated at Step S2, the second map-information Wₐₗₗ calculated at Step S4, and the third map-information Wᵥ calculated at Step S5; the second generator 106 decides on the luminance values of the pixels included in each display element (210 and 220) to thereby generate an image to be displayed on each display element (Step S6). Subsequently, the second generator 106 performs control to display the images generated at Step S6 on the display elements (210 and 220) (Step S7). For example, the second generator 106 controls the electrical potential of the electrodes of the liquid crystal displays and controls the driving of the light source 230 in such a way that the luminance values of the pixels of each display element (210 and 220) becomes equal to the luminance values decided at Step S6.

Meanwhile, in the case in which a plurality of parallax images is generated in a time-shared manner; every time the obtainer 101 obtains a plurality of parallax images, the operations starting from Step S2 are performed.

As described above, of a parallax image, the portion having a greater feature value is more likely to affect the image quality. In the embodiment, the luminance gradient of the parallax image, the gradient of the depth information, the depth position, and the object recognition result are used as the feature value. Moreover, also regarding the feature data Iₐₗₗ that is obtained as the weighted linear sum of the image information I_{g} in which the luminance gradient of the parallax image is treated as the pixel value, the image information I_{de} in which the luminance gradient of the depth information is treated as the pixel value, the image information I_{d} in which the depth position is treated as the pixel value, and the image information I_{obj} in which the object recognition result is treated as the pixel value; it is possible to think that the portion having the greater pixel value (first value) is more likely to affect the image quality.

Moreover, as described above, in the embodiment, for each of a plurality of model light rays defined according to the combinations of pixels included in the first display element 210 and the second display element 220, optimization is performed using the pixel value (the first value) of the feature data Iₐₗₗ corresponding to the model light ray as the priority. More particularly, using the first map-information L and the second map-information Wₐₗₗ, the luminance values of the pixels included in the first display element 210 as well as in the second display element 220 are decided in such a way that, greater the pixel value (the first value) of the feature data corresponding to the model light ray, higher is the priority with which the luminance value (the true luminance value) of the parallax image is obtained. That is, control is performed for optimizing the luminance values of the pixels of each display element (210 and 220) in such a way that a high image quality is obtained in the portion that is more likely to affect the image quality. As a result, it becomes possible to achieve a beneficial effect of being able to display stereoscopic images of a high image quality while achieving reduction in the number of laminated display elements.

### MODIFICATION EXAMPLES

Given below is the explanation of modification examples.

### (1) First Modification Example

For example, the second generator 106 can be decide on the luminance values of the pixels included in the first display element 210 as well as in the second display element 220 without taking into account the third map-information Wᵥ (i.e., without disposing the third calculator 105). In essence, as long as the second generator 106 decides on the luminance values of the pixels included in each of a plurality of display elements based on the first map-information and the second map-information, and generates an image to be displayed on each display element; it serves the purpose. More particularly, as long as the second generator 106 decides on the luminance values of the pixels included in each of a plurality of display elements in such a way that, greater the pixel value (the first value) of the feature data corresponding to the model light ray, higher is the priority with which the luminance value (the true luminance value) of the parallax image is obtained; it serves the purpose.

### (2) Second Modification Example

The first display element 210 and the second display element 220 included in the display 200 are not limited to be liquid crystal displays. Alternatively, it is possible to use plasma displays, field emission displays, or organic electro luminescence (organic EL) displays. For example, of the first display element 210 and the second display element 220, if the second display element 220 that is disposed farther away from the viewer 201 is configured with a self-luminescent display such as an organic EL display, then it becomes possible to omit the light source 230. However, if the second display element 220 is configured with a semi-self-luminescent display, then the light source 230 can also be used together.

### (3) Third Modification Example

In the embodiment described above, the explanation is given for an example in which the display 200 is configured with two display elements (210 and 220) that are disposed in a stack. However, that is not the only possible case. Alternatively, three or more display elements can also be disposed in a stack (can be laminated).

The embodiment described above and the modification examples thereof can be combined in an arbitrary manner.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
an obtainer configured to obtain a plurality of parallax images;
a first calculator configured to, for each of a plurality of light rays defined according to combinations of pixels included in each of a plurality of display elements that are disposed in a stack, calculate first map-information that is associated with a luminance value of the parallax image corresponding to the light ray;
a first generator configured to, for each of the plurality of parallax images, generate feature data in which a first value corresponding to a feature value of the parallax image is treated as a pixel value;
a second calculator configured to, based on the plurality of pieces of feature data respectively corresponding to the plurality of parallax images, calculate, for each of the light rays, second map-information that is associated with the first value of the feature data corresponding to the light ray; and
a second generator configured to, based on the first map-information and the second map-information, decide on luminance values of the pixels included in each of the plurality of display elements, to thereby generate an image to be displayed on each of the plurality of display elements.

2. The device according to claim 1, wherein the second generator decides on the luminance values of the pixels included in each of the plurality of display elements in such a way that, greater the first value of the feature data corresponding to the light ray, higher is priority with which the luminance value of the parallax image corresponding to the light ray is obtained.

3. The device according to claim 1, wherein
the feature value exhibits a greater value in proportion to a likelihood of affecting image quality, and
greater the feature value, greater is the first value.

4. The device according to claim 1, further comprising a third calculator configured to, for each of the light rays, calculate third map-information that is associated with a second value which is based on whether or not the light ray passes through a visible area that represents an area within which a viewer is able to view the stereoscopic image, wherein
based on the first map-information, the second map-information, and the third map-information, the second generator decides on the luminance values of the pixels included in each of the plurality of display elements.

5. The device according to claim 4, wherein
the second value in a case in which the light ray does not pass through the visible area is smaller as compared to the second value in a case in which the light ray passes through the visible area, and
the second generator decides on the luminance values of the pixels included in each of the plurality of display elements in such a way that, greater a result of multiplication of the first value and the second value of the feature data corresponding to the light ray, higher is priority with which the luminance value of the parallax image corresponding to the light ray is obtained.

6. The device according to claim 1, wherein the feature value represents either one of a luminance gradient of the parallax image, a gradient of depth information, a depth position obtained by converting the depth information in such a way that the depth position represents a greater value closer to a pop-out side, and an object recognition result defined in such a way that pixels corresponding to a recognized object represent greater values as compared to pixels not corresponding to the object.

7. The device according to claim 1, wherein
the feature value represents at least two of a luminance gradient of the parallax image, a gradient of depth information, a depth position obtained by converting the depth information in such a way that the depth position represents a greater value closer to a pop-out side, and an object recognition result defined in such a way that pixels corresponding to a recognized object represent greater values as compared to pixels not corresponding to the object, and
the first value is obtained based on a weighted linear sum of at least two of the luminance gradient of the parallax image, the gradient of the depth information, the depth position, and the object recognition result.

8. The device according to claim 1, wherein the first value is normalized to be equal to or greater than zero but equal to or smaller than one.

9. A stereoscopic image display device comprising:
a plurality of display devices disposed in a stack;
an obtainer configured to obtain a plurality of parallax images;
a first calculator configured to, for each of a plurality of light rays defined according to combinations of pixels included in each of the plurality of display elements, calculate first map-information that is associated with a luminance value of the parallax image corresponding to the light ray;
a first generator configured to, for each of the plurality of parallax images, generate feature data in which a first value corresponding to a feature value of the parallax image is treated as a pixel value;
a second calculator configured to, based on the plurality of pieces of feature data respectively corresponding to the plurality of parallax images, calculate, for each of the light rays, second map-information that is associated with the first value of the feature data corresponding to the light ray; and
a second generator configured to, based on the first map-information and the second map-information, decide on luminance values of the pixels included in each of the plurality of display elements, to thereby generate an image to be displayed on each of the plurality of display elements.

10. An image processing method comprising:
obtaining a plurality of parallax images;
calculating, for each of a plurality of light rays defined according to combinations of pixels included in each of a plurality of display elements disposed in a stack, first map-information that is associated with a luminance value of the parallax image corresponding to the light ray;
generating, for each of the plurality of parallax images, feature data in which a first value corresponding to a feature value of the parallax image is treated as a pixel value;
calculating, based on the plurality of pieces of feature data respectively corresponding to the plurality of parallax images, for each of the light rays, second map-information that is associated with the first value of the feature data corresponding to the light ray; and
deciding, based on the first map-information and the second map-information, on luminance values of the pixels included in each of the plurality of display elements, to thereby generate an image to be displayed on each of the plurality of display elements.
